(19) United States
(12) Patent Application Publication
(10) Pub. No.: US 2006/0085245 A1
(43) Pub. Date: Apr. 20, 2006

(54) Team collaboration system with business process management and records management

(75) Inventors: Allen Miki Takatsuka, Dove Canyon, CA (US); Nicki L. Tatalovich, Long Beach, CA (US); John Greene, Louisville, CO (US); Frank Hayes, Palos Verdes, CA (US); Daniel S. Whelan, Dana Point, CA (US)

Correspondence Address: MCDERMOTT WILL & EMERY LLP, 18191 VON KARMAN AVE., SUITE 500, IRVINE, CA, 92612-7108, US

(73) Assignee: FileNet Corporation

(21) Appl. No.: 11/251,831

(22) Filed: Oct. 18, 2005

Related U.S. Application Data
(60) Provisional application No. 60/620,090, filed on Oct. 19, 2004.

(51) Int. Cl. G06F 15/02

(52) U.S. Cl. 705/9

(57) ABSTRACT

A user-friendly web-based team collaboration solution that provides diverse team members the opportunity to participate in synchronous and asynchronous activities through a teamspace. Using a single platform that integrates team collaboration with business process management, team activities may be implemented through ad-hoc tasks and business process management driven steps to accomplish specific business objectives. Using this single platform, collaboration artifacts may also be managed through a records management system, thus making team collaboration efforts available as records. Numerous method variations, as well as related systems and computer-readable media are also disclosed.

### CROSS-REFERENCE TO RELATED APPLICATIONS

This application claims the benefit of priority under 35 U.S.C. § 119(e) from U.S. provisional application 60/620,090, filed Oct. 19, 2004, entitled “Team Collaboration System with Business Process Management and Records Management.” The entire content of this application is incorporated herein by reference.

### BACKGROUND

1. Field

The present disclosure relates generally to web collaboration and more particularly, to a web-based team collaboration environment wherein team members participate in activities with ad-hoc and business process management driven tasks to accomplish business objectives, and where collaboration artifacts are stored as records.

2. Related Art

Team collaboration has become increasingly popular over the years. This rise in popularity may be due—at least in part—to the fact that many businesses are now competing at a global level. As such, the need may arise for diverse teams to work on a common project from various physical locations or even across broad geographical regions. Accordingly, global competition may drive the need for companies to be more agile and collaborate over various locations and regions.

Technology has been developed to address the needs of team collaboration. For example, some document management systems have been created that allow users to collaborate on single documents or shared folders across a broad geographical region. The system may be set up as part of an intranet in order to promote basic security of document contents. Many of such solutions are intra-enterprise systems and do not provide for access outside the business. Document management systems may also be limited in that they promote collaboration on a limited number of types of software programs, such as word processing programs. Many companies have expressed needs for more expanded systems that accommodate additional software and communications, such as web-based applications. Many companies have also expressed a need for computer-based collaboration.

More advanced team collaboration systems were developed to address additional needs by providing a team workspace that incorporated capabilities such as discussion threads, ad-hoc tasks, polls, notes, calendars and notifications. These systems offered more robust security options and addressed usability issues that were associated with the more limited software and communications capabilities of many document management systems.

However, even the more advanced collaboration systems did not offer many capabilities desired by the business in order to make it more efficient and unified. For example, these team collaboration systems often offered silo repositories, that did not integrate with records management systems. Accordingly, business and compliance risks were present through the use of such systems. Moreover, these team collaboration systems did not accommodate certain types of content, such as web-based content.

Often, such systems were also offered separately from systems for other business activities such as records management, thus resulting in disparate systems which were not easily coordinated with one another. For example, content would often need to be repurposed in a records management system across the enterprise. These systems also resulted in higher total cost of ownership because separate systems were required to be purchased and maintained for team collaboration and records management. Moreover, for many of these systems, content was not easily searchable and thus, the content was not as useful if it was difficult to find. These systems were not user friendly. For example, a team may desire to re-use content that was created during one team collaboration effort in later efforts.

Economic considerations have forced some information technology departments to consolidate systems, thereby reducing administrative and development costs. These separate and distinct team collaboration systems and their silo approaches did not sufficiently address these issues associated with reducing administrative and development costs.

Moreover, because of issues related to corporate compliance as well as issues related to business efficiency, many companies have created well-defined business processes. These business processes are sometimes defined in terms of workflows in the context of a business process management (BPM) system. BPM workflows are frequently used to capture and automate well-defined, structured, repetitive, assembly-line-like business processes such as insurance claim processing or credit card application processing. Team collaboration systems, by comparison, are frequently used to organize and facilitate loosely-defined, unstructured, ad-hoc business processes that may or may not be repeated. Team collaboration is often concerned with group decision-making among knowledge workers, in areas such as mergers and acquisitions, budgeting, policy making, new product introduction, and complex insurance underwriting. Where team collaboration is concerned, it is desirable that such ad-hoc team collaboration processes may be governed by well-defined business processes, or integrated into these well-defined business processes.

Moreover, the workplace has evolved to include more intra- and inter-enterprise interaction. Companies now need a means to communicate both inside the company as well as outside the company, whether with partners, vendors or otherwise. Accordingly, there is a need for a team collaboration system that provides for both intra- and inter-enterprise interaction.

There is further a need for a team collaboration system that complies with other defined business processes for a company.

There is yet further a need for a team collaboration system that accommodates various types of content, including web-based content.

There is even further a need for a team collaboration system that is integrated with other repositories, e.g., records management systems, and allows a team to later re-use content created during previous collaborative or noncollaborative efforts.

### SUMMARY

The present disclosure addresses the needs noted above. In accordance with one embodiment of the present disclosure, a computer-implemented method is provided for ad-hoc collaboration tasks and business process management driven steps, comprising: creating a teamspace; receiving at least one ad-hoc task related to the teamspace; and implementing at least one business process management workflow related to the teamspace, wherein the at least one business process management workflow includes business process management steps; and wherein the teamspace or other collaboration-related artifact is automatically declared as a record.

In accordance with another embodiment of the present disclosure, computer readable media is provided containing programming for ad-hoc collaboration tasks and business process management driven steps that, when executed on a computer, causes a processor to perform the steps of: creating a teamspace; receiving at least one ad-hoc task related to the teamspace; and implementing at least one business process management workflow related to the teamspace, wherein the at least one business process management workflow includes business process management steps; and wherein the teamspace or other collaboration-related artifact is automatically stored as a record.

In accordance with still another embodiment of the present disclosure, a system is provided for ad-hoc collaboration and business process management driven steps, comprising: a device configured to create a teamspace; memory configured to receive at least one ad-hoc task related to the teamspace; and a process engine system configured to implement at least one business process management workflow related to the teamspace, wherein the at least one business process management workflow includes business process management steps; and a records management system configured to store the teamspace or other collaboration-related artifact as a record.

It is understood that other embodiments of the present disclosure will become readily apparent to those skilled in the art from the following detailed description, wherein it is shown and described only exemplary embodiments of the disclosure by way of illustration.

### BRIEF DESCRIPTION OF DRAWINGS

Aspects of the present disclosure are illustrated by way of example, and not by way of limitation, in the accompanying drawings wherein:

FIG. 1 illustrates a block diagram representation of a single architecture for ad-hoc collaboration and business-process management driven tasks in accordance with one embodiment of the present disclosure.

FIG. 2 illustrates a process designer tool that can be used to define a workflow which may, in turn, be used to create a teamspace in accordance with one embodiment of the present disclosure.

FIG. 3 illustrates a screenshot of a teamspace that may be created in accordance with another embodiment of the present disclosure.

FIG. 4 illustrates a tasks screenshot that might be provided through selection of a task icon in accordance with one embodiment of the present disclosure.

FIG. 5 illustrates a meeting screenshot that might result when a meeting icon is selected in accordance with one embodiment of the present disclosure.

FIG. 6 illustrates a document screenshot that might result through selection of the document icon in accordance with one embodiment of the present disclosure.

FIG. 7 illustrates a discussion screenshot that may result when the discussion icon is selected in accordance with one embodiment of the present disclosure.

FIG. 8 illustrates a poll screenshot that may result when a user selects a poll icon from a teamspace in accordance with one embodiment of the present disclosure.

FIG. 9 illustrates a people & teams screenshot that may result when a user selects a people & teams icon in accordance with one embodiment of the present disclosure.

FIG. 10 illustrates an e-mail screenshot that may result when a user elects to access e-mail capabilities from a teamspace in accordance with one embodiment of the present disclosure.

FIG. 11 illustrates a search screenshot that may result when a user elects to search information from a teamspace in accordance with one embodiment of the present disclosure.

FIG. 12 illustrates a screenshot that might be viewed when a user elects to launch a workflow from within a collaborative environment or a teamspace display.

FIG. 13 illustrates a screenshot showing how a workflow might create a teamspace in accordance with one embodiment of the present disclosure.

### DETAILED DESCRIPTION OF THE PRESENT DISCLOSURE

The present disclosure provides methods, computer programs and systems for a web-based team collaboration environment wherein team members participate in synchronous and asynchronous activities with ad-hoc tasks as well as business process management driven tasks to accomplish specific business objectives. Collaboration artifacts may be stored as records.

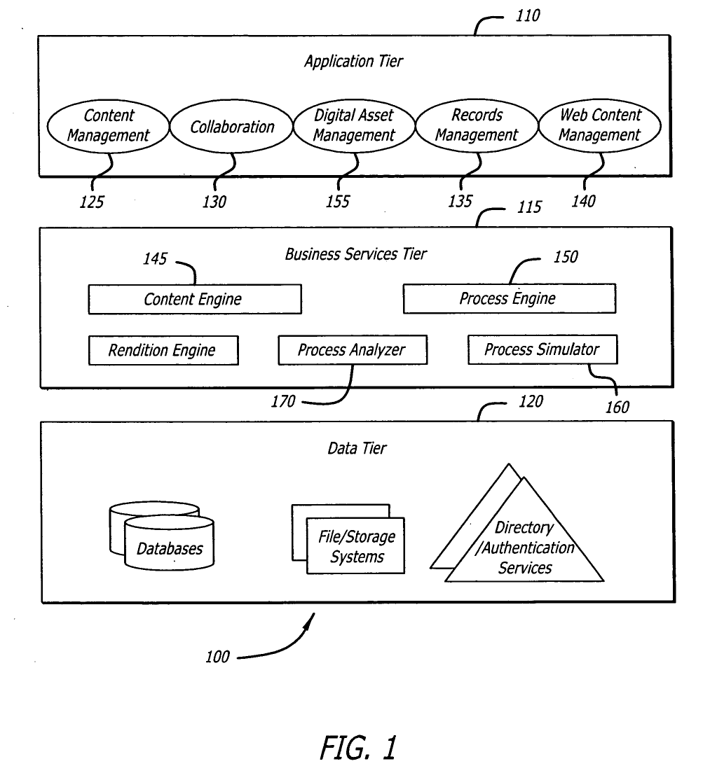

The present disclosure provides for integration of team collaboration with business process management, enterprise content management, and records management using a single platform. Referring now to FIG. 1, illustrated is a block diagram representation of a single architecture 100 that includes an application tier 110 built on a platform that includes a business services tier 115, and a data tier 120. A single architecture may be provided thereby for collaboration system 130, records management 135, web content management 140, digital asset management 155 and content management 125 at the application tier, while a content engine 145 and a process engine system 150 are used to manage the processes and content for all the separate systems that perform collaboration 130, records management 135, web content management 140, content management 125 and digital asset management 155.

Using this architecture, business process management may be performed such that the collaboration system 130 may be configured to initiate—automatically or otherwise—one or more processes in the process engine system 150, and vice versa. These processes may be ad-hoc tasks associated with collaboration or well-defined business processes that are to be performed in conjunction with collaboration.

The team collaboration system 130 may be used to manage teams and tasks. Members of teamspaces may interact to manage ad-hoc tasks. A teamspace may include zero teams (pre-implementation), or one or more teams (post-implementation). Workflow processes may create these tasks in a well-determined manner, thereby providing a well-defined sequence of business steps from which collaborative work may be initiated. In addition, a user may launch business workflows from a teamspace. The user may also launch business workflows from outside the teamspace. Moreover, a teamspace can be automatically created from a business workflow.

A process simulator 160 may be used to model business processes and simulate them under real-world conditions. By taking existing processes and simulating various scenarios based on relevant data, a business may discover how to remove bottlenecks, better align resources and reduce overall costs.

A process analyzer 170 may be used to deliver dynamic reports with historical and real-time data that enable a business to monitor and analyze processes, optimize operations and proactively address business trends. The process analyzer 170 may be based on on-line analytical processing (OLAP) technology, and it may track the performance of key business processes. The process analyzer 170 may also be used in connection with the collaborative environment.

Using the above-described architecture 100, when collaboration content is added to the system, the content may also be published or declared as a record. In this manner, the records may be managed within the system, and content may be managed both inside and outside the system. For example, after a collaborative effort is completed, the system may automatically classify one or more of the records or store information associated with one or more of these collaborative records in the records management system. The teamspace itself may be the record.

Other capabilities resulting from this architecture 100 may include management of web content 140 and management of other types of content in connection with a team collaboration environment such that the content may be published seamlessly to appropriate web sites. Because of this integration, teamspaces may become templates for capturing best practices, providing for ease of use.

The present disclosure may be used to provide a seamless integration of the collaboration environment with business process management technology. The present disclosure may be used in team collaboration environments, including, by way of example, project management and new product introduction. The concepts described in the present disclosure may be used in such environments to, among other things, expedite delivery or promote project objectives.

Alternatively, one or more of the various management applications of the application tier 110 may be a part of separate, stand-alone systems that have been brought together and integrated merely for the purpose of creating the collaboration system with business process management and/or records management.

Team Collaboration.

In accordance with the present disclosure, team collaboration may occur within a web-based environment wherein team members participate in synchronous and asynchronous activities with ad-hoc tasks as well as business process management driven tasks to accomplish business objectives. A synchronous task may be defined as a task which must be completed before another task in a workflow may begin. In other words, the workflow must wait until the task is completed. An asynchronous task may be defined as a task that need not be completed before another task is begun, and asynchronous tasks may run in parallel with each other.

Collaboration may relate to ad-hoc tasks designed to accomplish a specific business objective. As such, some forms of collaboration may require a high level of manual intervention. Through the integration of collaboration with business process management, business process management workflows may be used to automate very well defined and formal processes used to accomplish business objectives.

The system of the present disclosure supports easy customization. Menu actions may be added that trigger custom code. Accordingly, menu items may be easily added that integrate with legacy business systems.

The present disclosure may be used to manage teams and tasks. In addition to its use as an end-user collaboration tool for teams/projects, a teamspace may also be used to enable partners and ISVs (independent software vendors) to build collaboration-enabled industry-specific solutions. In this respect, the team collaboration tool of the present disclosure may offer both an intra-enterprise solution as well as an inter-enterprise solution so that employees of a business may interact with one another. This team collaboration tool may also offer an inter-enterprise solution so that employees of different companies may collaborate with one another.

Because of the integration between collaboration and business process management, workflow steps may be designed to be performed through collaboration. Steps of a business process management workflow may also be designed to control some tasks within a collaboration. Workflow users may use collaboration as a means to accomplish a task assigned to them.

A teamspace may be defined as a web-based environment where team members access asynchronous tools. A teamspace may be created on the fly. However, it should be noted that the initiation of a teamspace may also be controlled, for example, with the discretion of an information technology department. In these cases, teamspace creation may be limited to certain persons, departments/groups or otherwise.

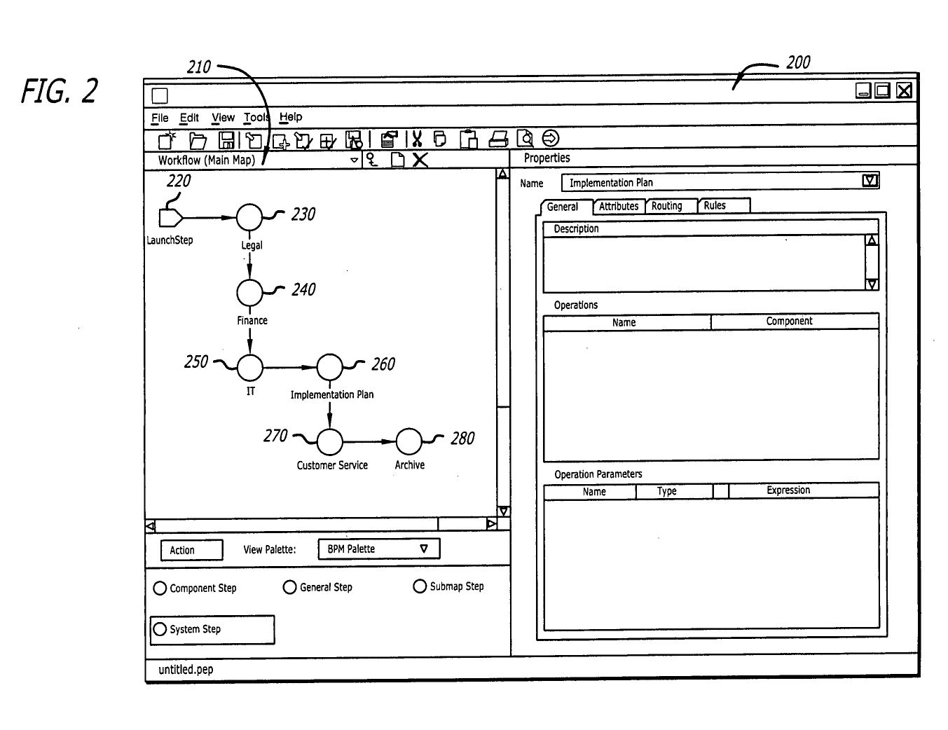

In accordance with one embodiment of the present disclosure, a teamspace may be created from a workflow which has been designed using a process designer. FIG. 2 illustrates a process designer tool that can be used to define a workflow. This workflow may, in turn, be used to create a teamspace in accordance with one embodiment of the present disclosure. In the illustrated workflow 210, this teamspace may have been created in connection with an implementation plan. Workflow 210 has been designed to include a step to create a teamspace for the implementation plan. When the workflow is executed and the step for teamspace creation is reached, a teamspace may be created to make an implementation plan.

In this scenario, prior to actual implementation, a proposed implementation plan may be reviewed by various departments, including legal, finance and information technology (IT). Collaboration may be performed on the implementation plan, which may include gathering customer requirements and validation of the plan, prior to having the plan implemented or reviewed by customer service. This particular workflow may be launched at step 220, and the implementation plan may be reviewed by legal at step 230, then by finance at step 240, and by IT at step 250.

At step 260, the implementation plan workflow creates a teamspace prior to being sent for implementation by customer service at step 270. Records relating to the implementation plan may be archived at step 280 because the present disclosure provides a single platform that integrates business process management with team collaboration as well as integration with records management. Because of this integration, the system may perform various functions associated with business processes, team collaboration and records management seamlessly. Each of these functionalities may interoperate with one another to create a powerful business tool.

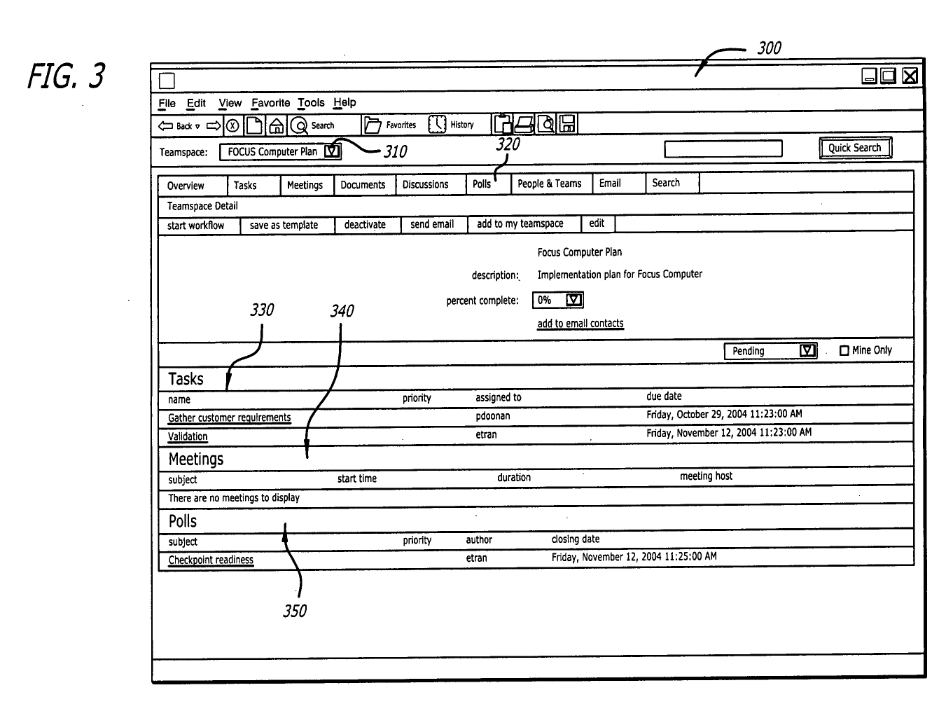

As indicated, step 260 of FIG. 2 may be used to create a teamspace as part of the implementation plan for Focus Computer. Details of how such a teamspace may be created or designed are provided later in this application. Referring now to FIG. 3, illustrated is a screenshot 300 of a teamspace that may be created in accordance with one embodiment of the present disclosure. As illustrated, the teamspace name is Focus Computer Plan as illustrated in block 310 of the screenshot 300. (It should be noted that other teamspaces may be accessed by selecting the dropdown menu at block 310). From a teamspace, management of team members may be accomplished. The team members may also share content, and their content may be secure.

A teamspace may incorporate a number of capabilities, including discussion threads, ad-hoc tasks, polls, as well as calendars and notifications, among others.

As illustrated by the icons in row 320 of screenshot 300, various functionalities and information may be made available through the teamspace. For example, an overview may be provided for the teamspace and may include a description of the purpose and goals of the pertinent teamspace.

As illustrated in the tasks section 330 of screenshot 300, outstanding tasks may be illustrated, including the name of the task, priority assigned to the task, persons responsible for carrying out the task, and the due date for the task. In this illustration, two outstanding tasks are shown. Per the first task, user pdoonan has been assigned the task of gathering customer requirements. The due date for this first task is Oct. 29, 2004. Per the second task, user etran has been assigned the task of validation. The due date for this second task is Nov. 12, 2004.

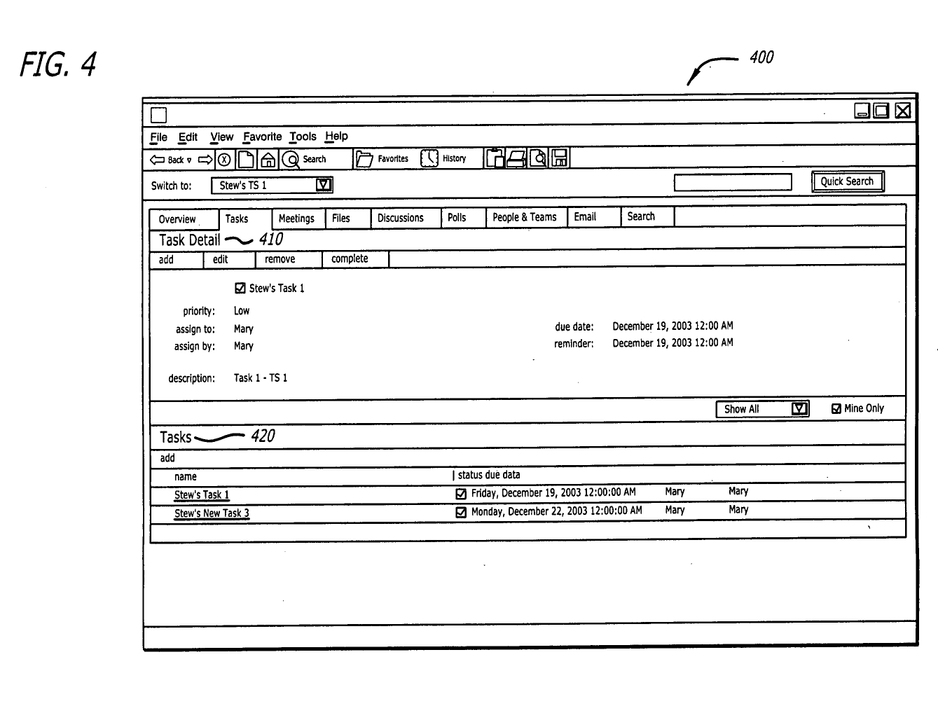

Tasks for the teamspace may be accessible through the task icon as shown in row 320 of the teamspace screenshot 300. Referring now to FIG. 4, illustrated is a tasks screenshot 400 that might be provided through selection of the task icon. The current task is on Stew's TS 1, the name of the teamspace. This teamspace is a different one from that described in the previous figure. As indicated, a user may select from a number of teamspaces that the user is authorized to view, by selecting the teamspace from a dropdown menu.

In the teamspace named Stew's TS 1, details may be relayed concerning the two teamspace tasks in the task detail portion 410 of screenshot 400 when the user selects a particular task for which the user would like details. The tasks for which the user may request details are illustrated in the tasks section 420 of screenshot 400. In the tasks portion 420, the two teamspace tasks illustrated are titled Stew's New Task 3 and Stew's Task 1. Other general information regarding these tasks are also shown at the tasks portion 420 of screenshot 400. Task priority is indicated with an arrow for one task, indicating lower priority. An exclamation point (!) such as the one shown for Stew's New Task 3 may be used to indicate a higher priority task.

The status of the task is shown as complete by the check marks inline with the name of the task in the tasks portion 420 of screenshot 400. Both Stew's Task 1 and Stew's New Task 3 have been completed as illustrated by these check marks. The due dates for the tasks are also shown inline with the name of the task. For Stew's Task 1, the due date was Friday, Dec. 19, 2003 at 12:00:00 a.m. For Stew's New Task 3, the due date was Monday, Dec. 22, 2003. The tasks portion 420 of screenshot 400 indicates that both Stew's Task 1 and Stew's New Task 3 were assigned to Mary, and that these tasks were also assigned by Mary. Members of teamspaces may interact to manage ad-hoc tasks.

As indicated, ad-hoc tasks may be implemented by including basic information about the task. In this case, Mary assigned herself the illustrated ad-hoc tasks.

Because Mary's tasks have been completed, they are not shown as pending in the right hand portion of the tasks portion 420 of the screen. If the tasks were indeed pending, an icon such as an empty box without a check mark might illustrate that the task inline with the empty box was pending.

In this illustration, further details have been requested regarding Stew's Task 1 by selecting or highlighting this task at the tasks portion 420 of the screen. In the task detail portion 410 of screenshot 400, task details may be added, edited, removed, or completed. In this illustration, further details are given to the user about the task, particularly, that a reminder was sent about the task on Dec. 19, 2003, and the priority is called out as low.

In lieu of ad-hoc tasks, workflow processes may create these tasks in a well-determined manner, thereby providing a well-defined sequence of business steps from which collaborative work may be initiated.

Referring back to FIG. 3, information regarding teamspace meetings may be accessible through a meeting icon at row 320. Meeting dates and times relevant to the teamspace may be made available as part of a larger calendar program. Calendars may also be presented as chronological views of teamspace events such as tasks and poll due dates and meetings. Notification of teamspace events, such as new task assignments, modification of content, and invitations to join a teamspace may be sent to the appropriate team members via e-mail. Users may have the authority to determine how often they wish to be notified by subscribing to particular events.

In the screenshot 300 of FIG. 3, outstanding meetings may be displayed in the meetings section 340 of screenshot 300. As shown, there are no outstanding meetings for the teamspace. If at least one meeting had been outstanding, details related to the meeting could be displayed, including but not limited to, the subject of the meeting, the start time, the duration of the meeting, and the host of the meeting.

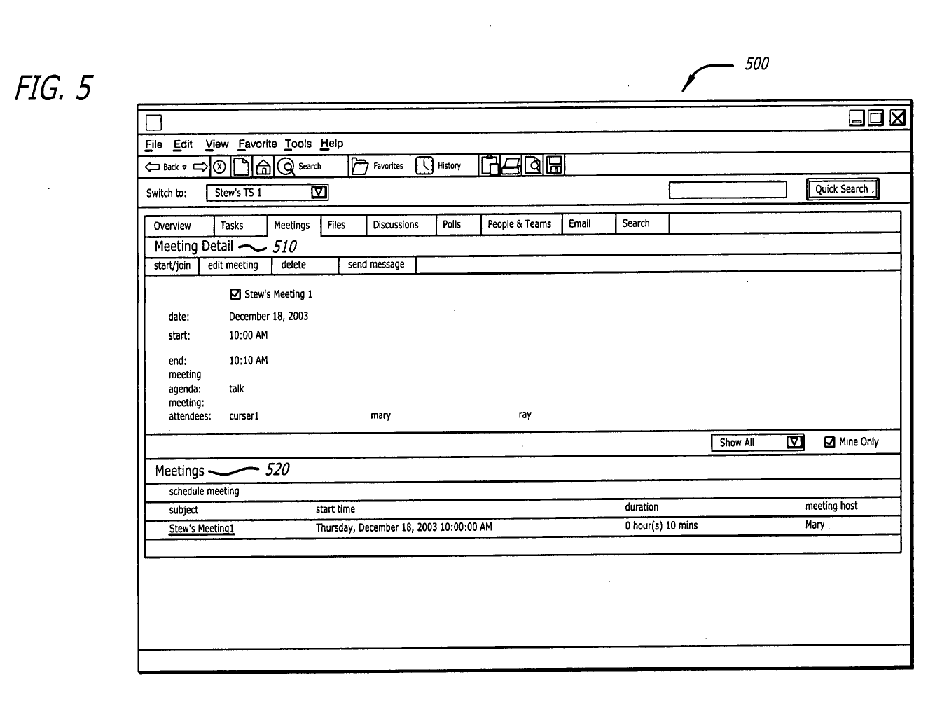

As indicated above, by selection of the meeting icon in row 320, meeting capabilities and information for teamspaces may be accessed. Referring now to FIG. 5, illustrated is a meeting screenshot 500 that might result when a meeting icon is selected. This screenshot 500 includes the two main sections of meeting detail 510 and meetings 520. By selecting a meeting from those listed in the meetings section 520, further details regarding a particular meeting may be accessed.

In this screenshot, only one meeting was scheduled as illustrated in the meetings section 520. General information regarding the meeting is shown in the meetings section. The subject of the meeting is Stew's Meeting 1, the start time was Dec. 18, 2003, the meeting lasted 10 minutes and was hosted by Mary. From the meetings section 520 of the screenshot, the user may elect to schedule a meeting and enter meeting details. The user may also wish to view only those meetings related to the user by placing a check in the box marked “mine only.” Alternatively, the user may wish to view all teamspace meetings as a default selection of the system to “show all,” by electing not to check the box “mine only.”

In the meeting detail section 510 of screenshot 500, further details are illustrated regarding Stew's Meeting 1. Particularly, the meeting agenda is shown as well as the names or user ID's of the meeting attendees. In the current illustration, persons with user ID's cuser1, mary and ray attended the meeting.

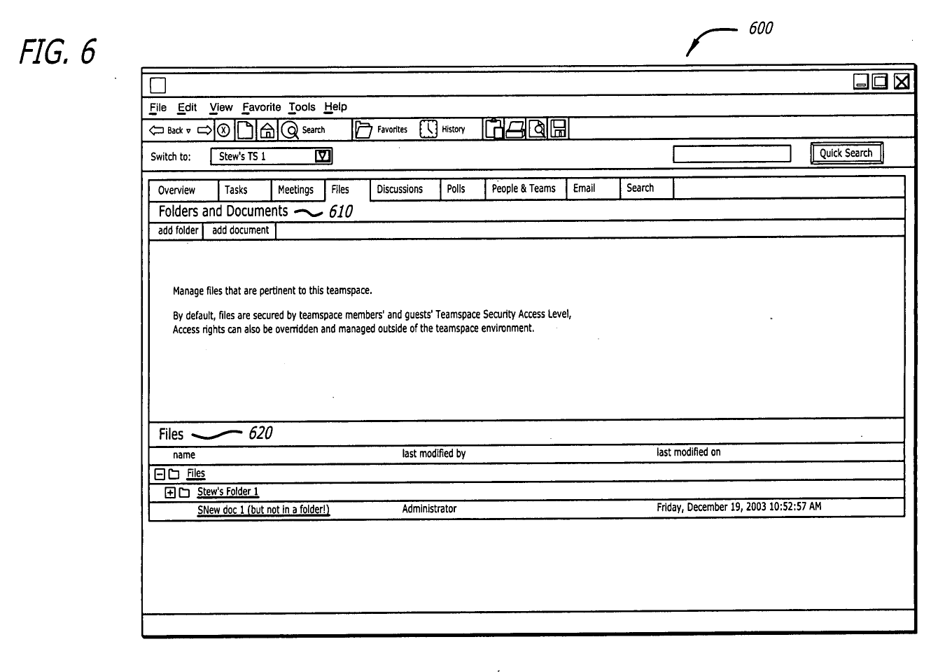

Documents that have been created through the teamspace may be accessed through a document icon in row 320. Because of the integration between team collaboration and records management, records created through teamspaces may be archived similarly to other business records as set out in greater detail hereinbelow. Referring now to FIG. 6, illustrated is a document screenshot 600 that might result through selection of the document icon. The screenshot 600 is divided into two main sections—the folders and documents section 610 and the files section 620.

As indicated in document screenshot 600, the folders and documents section 610 may be used to manage files that are pertinent to the teamspace. By default, the files may be secured according to a security access level for teamspace members and guests. A user may add a folder or a document to the teamspace. Access rights may be overridden and managed outside of the teamspace environment, e.g., by the IT department. Comments may be used as notes against specific collaboration objects such as documents or tasks. The comments may then be altered and, with each comment, a user, date and time stamp may be noted. In the files section 620 of screenshot 600, illustrated is general information related to a file for Stew's TS 1.

Referring back to FIG. 3, as yet another example of capabilities provided through team collaboration, discussion capabilities may be accessible through a discussion icon in row 320. Discussion threads may be initiated by authorized end users when they create topics and post comments and replies. The discussion thread may be presented in a hierarchical fashion. The unalterable postings may be stamped with user, date and time information.

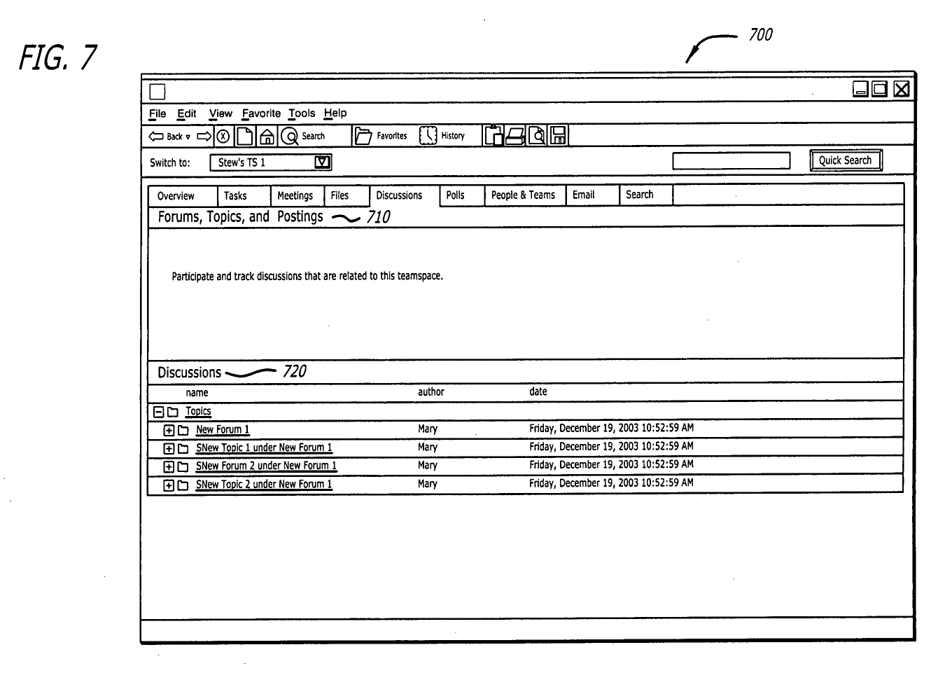

As stated, further discussion capabilities may be accessed by selecting the discussion icon in row 320. Referring now to FIG. 7, illustrated is a discussion screenshot 700 that may result when the discussion icon is selected. As indicated in FIG. 7, the discussion screenshot 700 may be segmented into two main sections—the forums, topics and postings section 710 and the discussions section 720. As with the other screenshots illustrating capabilities accessible through an icon on a teamspace, the upper section, i.e., the forums, topics and postings section 710 reveals details regarding the discussions, while the bottom section, i.e., the discussions section 720 relays general information regarding the discussion.

Polls may be conducted through a teamspace, and such polls may represent online surveys for team members to vote on specific issues. Poll results may be user, date and time-stamped. As illustrated in a polls section 350 of screenshot 300, one poll is outstanding. As illustrated, the poll relates to checkpoint readiness and team members may vote on checkpoint readiness by the closing date of Nov. 12, 2004 at 11:25:00 a.m. Poll operations may be accessible through poll icon on row 320.

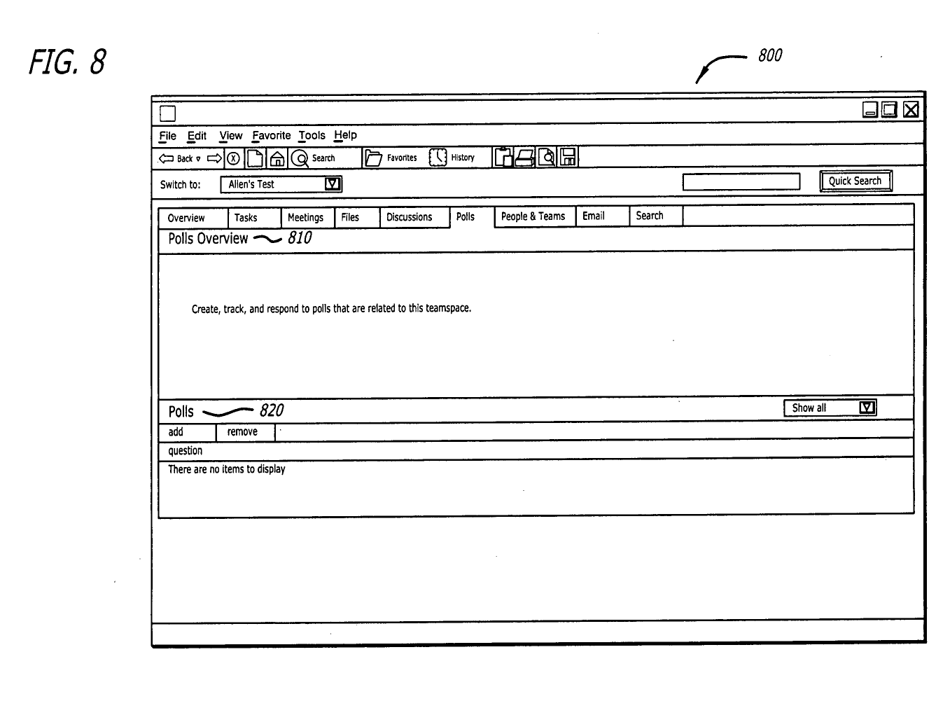

Referring now to FIG. 8, illustrated is a poll screenshot 800 that may result when a user selects a poll icon from a teamspace. The screenshot is divided into two segments—the polls overview section 810 relays detailed information about a poll that may be selected from the polls section 820.

Referring back to FIG. 3, as yet another example of teamspace capabilities, illustrated is a people & teams icon on the display of screenshot 300 at row 320. When the people & teams icon is selected, further capabilities may be accessed related to people and teams.

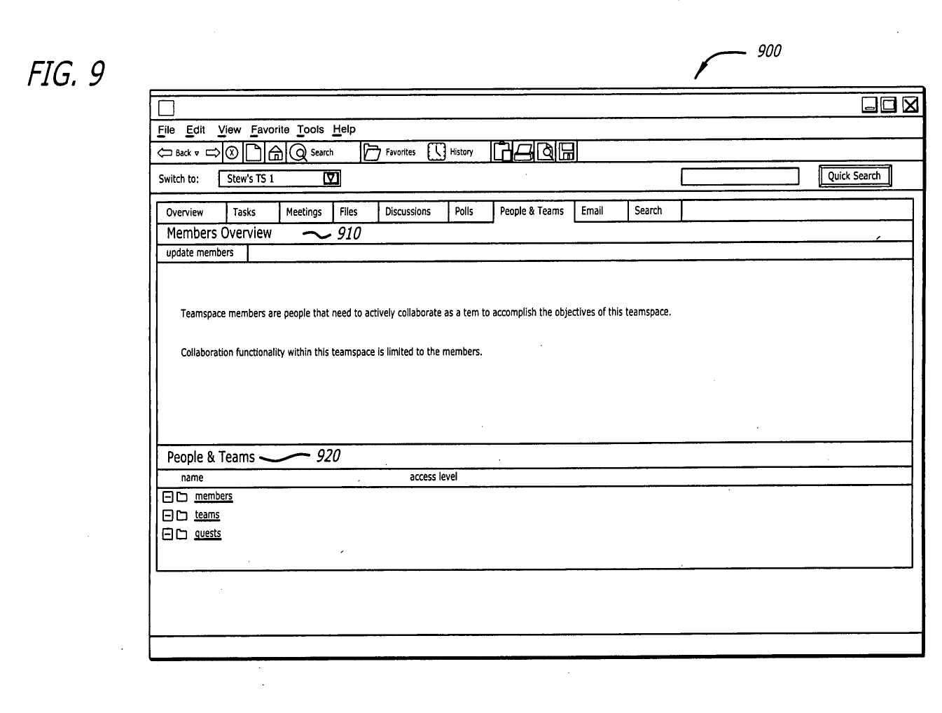

Referring now to FIG. 9, illustrated is a people & teams screenshot 900 that may result when a user selects a people & teams icon. As indicated, the members overview segment 910 of screenshot 900 may show members who are eligible to actively collaborate as a team to accomplish the objectives of the teamspace. Collaboration functionality may be limited to the members.

Although collaboration functionality may be limited to members, other teams and guests may have access to the teamspace, but might not be able to collaborate. As illustrated the people & teams section 920 of screenshot 900 would allow the user to display information regarding members, teams and guests if the pertinent link were to be selected or highlighted.

Referring back to FIG. 3, illustrated in row 320 is also an e-mails icon. A user may select this icon to access e-mail capabilities related to the teamspace.

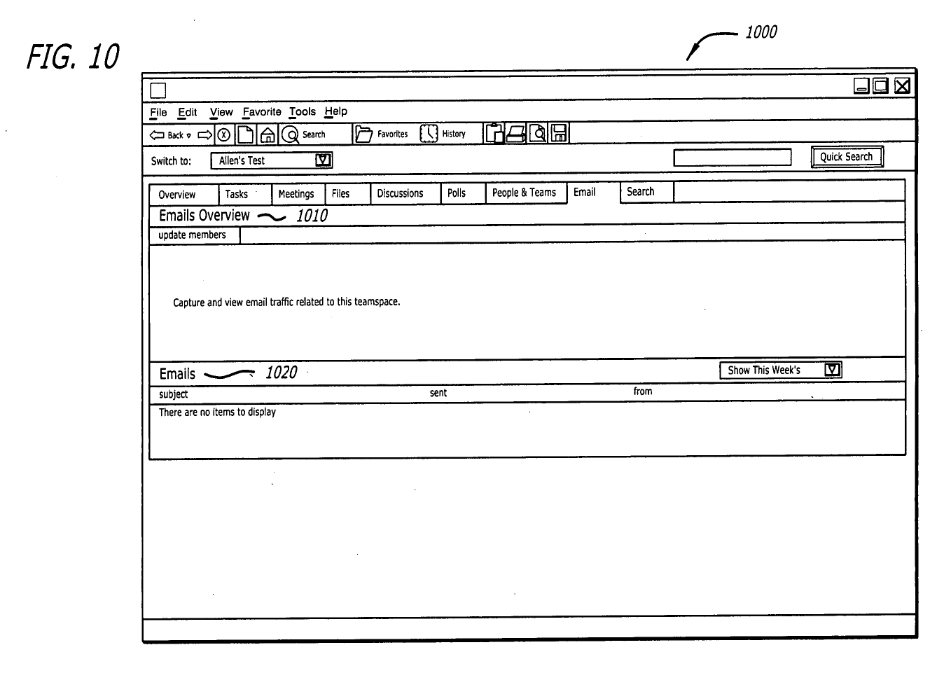

Referring now to FIG. 10, illustrated is an e-mail screenshot 1000 that may result when a user elects to access the e-mail capabilities from the e-mail icon on the previous screen. The e-mails section 1020 of the screen may be used to relay general information about one or more e-mails related to the teamspace, including the date each e-mail was sent and the sender of each e-mail. While in this illustration, no e-mails are available to display, in a teamspace where e-mails were available, the user might select or highlight the e-mail from the e-mails section 1020, and information related to the e-mail might be shown in the e-mails overview section 1010.

Referring back to FIG. 3, the teamspace also incorporates search capabilities accessible via a search icon in row 320.

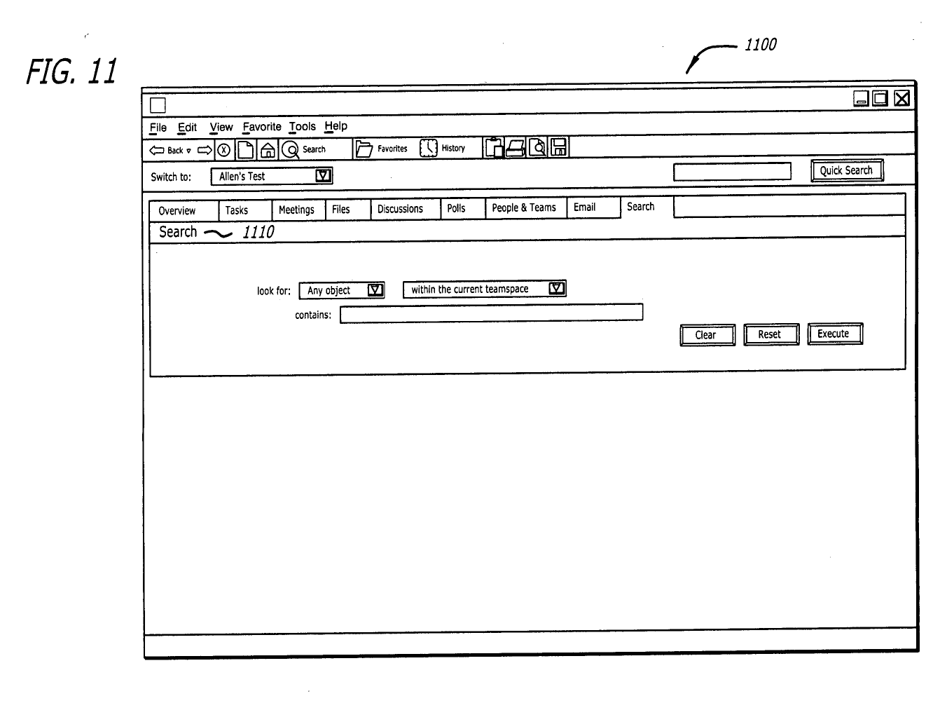

Referring now to FIG. 11, illustrated is a search screenshot 1100 that may result when a user elects to search information from a teamspace. Users may also search for content in the object store, including content that is not related to a teamspace. The content may have been created by users through various applications configured to generate content. It is possible to tie in this search functionality with a records management system such that the business's records may be searched from a teamspace. According to user access rights, the availability of the records may be limited.

Integration of Business Process Management with Team Collaboration:

Team collaboration may integrate with a business process management system in a number of ways. For example, a workflow may be launched within a collaboration environment, particularly from a teamspace or from a document within a collaboration environment. A workflow subscription may be established for a user through a platform configuration. Such a configuration may allow the user to choose from workflows that are available through the subscription. A workflow subscription is generally available only to those users with the proper permissions to use the workflows within the subscription. Alternatively, a workflow may create a collaboration teamspace or a specific collaboration task.

A workflow may also control the flow of collaboration tasks. A workflow may add content to a teamspace. A workflow may be created using collaboration steps. A workflow may also be launched within the collaboration environment. Ad-hoc collaboration may occur using a workflow step.

A workflow may be launched within a collaboration environment. A collaboration environment may be defined to include the configuration of a collaboration store and its teamspace capabilities. A collaboration store administrator may configure object store workflows that may then be made available to the collaboration environment. A collaboration store may span object stores. The workflow definitions may reside in an object store. Such configured workflows may be registered with a teamspace, document, or folder. In some cases, no configuration may be necessary. For example, the platform configuration used in conjunction with the present disclosure may be leveraged directly so that workflows may be configured. These workflows are made available to the user in a collaboration environment.

The business process management system may be used to implement workflow processes that capture a business process and automate the process within a collaborative environment. A workflow process or automated business process may be defined as a series of processing steps in a particular sequence, where each step could involve user input and work or automated processing.

For example, as part of its line of business, an insurance company may approve or deny claims. This approval or denial process may be performed in discrete steps and may be expressed in terms of a workflow process. At a first step, the claim process may be initiated whereby an insured makes a claim against his policy. At a second step, an estimate may be received by the insurance company. The estimate may be received directly from the insured, from a company that performs the estimate, or any other entity from which the insurance company desires to obtain an estimate. At a third step, accident data may be received. If the accident involves an injury, data related to the injury may also be obtained at a fourth step. At a fifth step, the claim is processed, then approved at a sixth step. At a final step, a check may be issued in the amount approved.

A workflow process may also involve an automated computer program (e.g., an automated programmatic check of policy coverage and limits in the course of processing an insurance claim). Workflow processes in accordance with the present disclosure may be designed by system analysts and may be recorded in a process engine. In this manner, they may be executed repeatedly in the course of running a business.

A process simulator within the business management system may be used to provide business process simulations prior to deployment of a workflow process. In this manner, it may be determined whether a proposed or implemented process is effective and free of errors. The simulator may also be designed to ensure that the most optimal processes are deployed to deliver maximum value to the business. Where a process has been previously deployed, the process simulator may be used to ensure the deployed process is optimally tuned based on current business conditions. Such a deployed process may also be simulated based on expected or future conditions.

The process simulator may be a fully integrated component of a business process management system. The process simulator may be implemented with a process designer as well as a process analyzer, with the objective of improving business efficiency. The process analyzer and process designer may also be a part of the business process management system.

The process analyzer may offer a complete range of dynamic reporting options to view and analyze data. Data may be viewed according to a year, quarter, week, day or other time period. Data may be filtered so that only certain data is shown. Further details may be provided on the data in a rollover function that allows exact detail to be shown for a particular data item. Data may also be viewed from various perspectives.

Using the process analyzer, a business may store and view statistics related to work items, gather real time status information on work objects and workflows, display statistics, show the time used to process workflow items, or simply view the processing time of a particular group, user or automated process.

Launching a Workflow Within a Collaboration Environment:

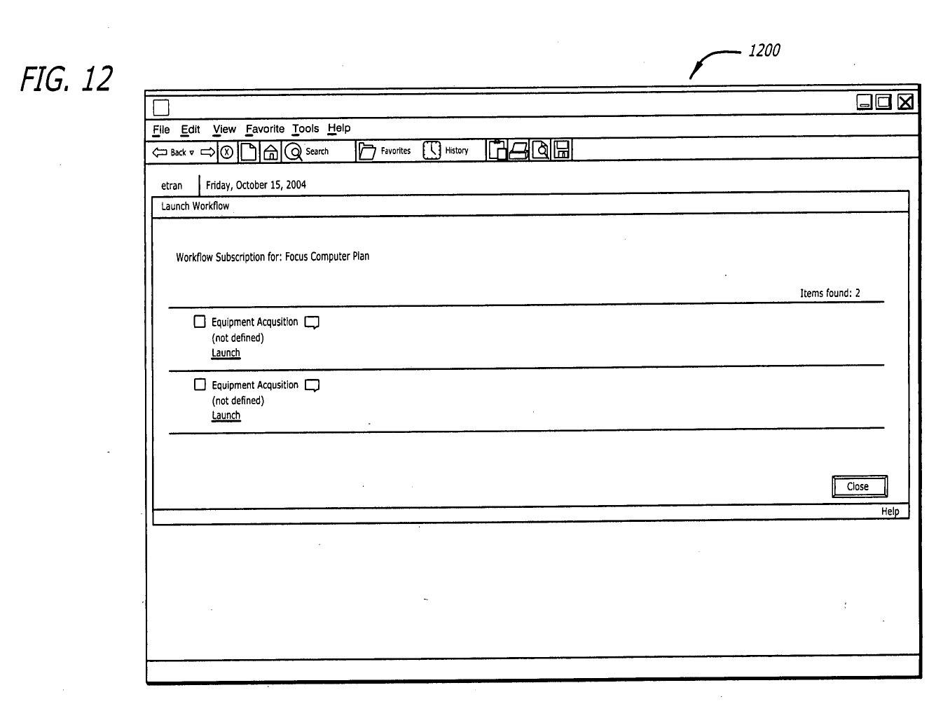

Referring now to FIG. 12, illustrated is a screenshot 1200 that might be viewed when a user elects to launch a workflow from within a collaborative environment or a teamspace display. In this illustration, the display indicates that two workflows have been registered for the teamspace related to a Focus Computer Plan. The first workflow relates to equipment acquisition. The second workflow relates to getting user information.

A member of a collaborative team may select one of the registered workflows. This selection may trigger a launch action and the workflow's launch step may be run. The manner in which the launch step processor runs depends on how the workflow was designed and could be a workplace (described in greater detail below) launch step processor or another launch step processor. If the launch step requires an initiating attachment then the appropriate data will be provided as an initiating attachment. An initiating attachment may be defined as content that initiates a workflow, and where the content becomes an attachment as part of the workflow. For example, if a user opens a document, launches a workflow, and anticipates that the document may be a subject of the workflow, the original document is the initiating attachment.

Alternatively, the workflow may also be launched from a document associated with a teamspace. A user in a collaborative environment may select a document in the tree view of the collaboration application which sets a context sensitive menu for the selected item. The context sensitive menu may display an option to launch a workflow. If the user selects the pertinent icon(s) and launches a workflow, a new page may be displayed. The page may contain a list of workflows registered for documents along with a launch and cancel button. The user may then select a workflow and trigger the launch action. The workflow would begin at the launch step. If the launch step requires an initiating attachment, then the document may be provided.

For example, a teamspace member may need to publish a document. In order to execute this function, the member may open the teamspace, navigate to the document, and select to launch workflow. The teamspace member may select from a list the “Publish” workflow and then select to launch the workflow. This launch would fire off the well known organizational workflow to publish a document.

Similarly to the manner in which workflows are launched from a document, the workflow may also be launched from a folder. The user may select a folder from a tree view.

Using a Workflow to Create a Collaboration Teamspace:

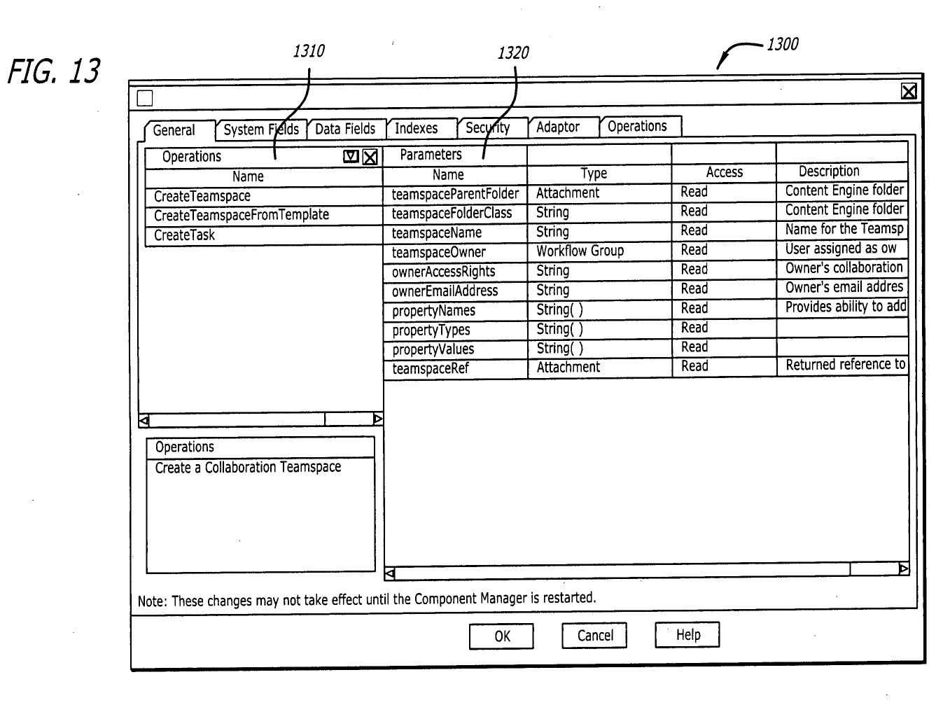

A workflow may also create a collaboration teamspace. Referring now to FIG. 13, illustrated is a screenshot 1300 showing the interface through which a teamspace may be created in accordance with one embodiment of the present disclosure. As shown in the top portion of screen, the designer has chosen the operations tab 1310 in order to access the operations screen from which the designer may choose from options related to creating a teamspace or creating a task. As shown in the upper left column 1320 of the screenshot, the designer may choose to have the workflow create a teamspace, create a teamspace from a template, or create a task.

The designer may also choose parameters for the teamspace as shown in the parameter portion 1330 of the screenshot. As illustrated, the parameters may each have a name, type, access rights and description. The name may indicate a brief description of the parameter. The type of parameter may be a parent folder, folder class, space name, owner access rights, owner email address, property names, property types, property values or a teamspace reference. However, it should be understood that the teamspace parameters may be any parameter deemed important for the teamspace.

A process designer may specify workflow steps to create a collaboration teamspace. The designer may choose how the workflow operates. The designer may choose to create the workflow with data hard coded into the workflow such that the workflow executes without user intervention, and creates a teamspace. Alternatively, the workflow may be used to gather and pass information about the teamspace it wants to create to the collaboration step. A component integrator, such as that disclosed in concurrently pending application Ser. No. 10/745,463, entitled “Component Integrator,” with inventors Michael G. Winter et al., assigned to the assignee of the present disclosure, may be used to make collaboration operations available within a workflow step, such as teamspace creation or collaboration task creation. The component integrator may also perform functions such as ensuring that only those with the proper credentials or access rights, e.g., an administrator, may create a teamspace or add workflows to a teamspace. This concurrently pending application is fully incorporated by reference herein.

The teamspace may be created in a teamspaces folder under a root folder of a collaboration-enabled object store. The teamspace may be searchable from any location within the collaboration-enabled object store. The teamspace may be created under any folder in an object store.

To create a teamspace, certain parameters may be required. A content engine object store name may be used to identify the location of content related to the teamspace. A parent folder may show the folder in which the teamspace was created. A teamspace name may be used to identify the teamspace. The teamspace may have a teamspace owner, which may be the member ID used to create the teamspace. The teamspace owner may also have a security access level which might allow the teamspace owner to control the teamspace since no other members are added at this time.

Alternatively, the teamspace may be created from a template as shown in the operations segment 1310 of screenshot 1300. The template may include basic information used to generate a teamspace. Templates may be generated from teamspaces or from workflows. The process designer may input the same parameters that are used in creating a teamspace without a template, e.g., parent folder, folder class, space name, owner access rights may be input by the process designer. However, other parameters may be required, such as a template from which the teamspace is to be created.

Using a Workflow to Create a Collaboration Task:

A workflow may be used to create a collaborative task as indicated in the operations segment 1310 of screenshot 1300. The workflow may also be used to control the flow of the collaboration task, in which case the collaboration task may be workflow aware and may need to re-dispatch the workflow so it may continue.

The workflow creation may also occur such that it passes information about the collaboration task it is to create. Certain parameters may be input relevant to this workflow. For example, the designer may specify the location of the teamspace object store in a content engine. The process designer may specify a name for the task. In the case of a workflow step that creates an ad-hoc task in a collaboration teamspace, the task name could be set to the same name as the workflow step name. A task assigner may also be specified by the process designer, in which case the task assigner may receive an email in the collaboration environment when the task is due, or a reminder date has arrived, or when the task is completed.

The parameters might also include a task assignee who may receive an email in the collaborative environment notifying the assignee that a task has been assigned, and giving the assignee pertinent due dates and reminders. The system may be set so that the task assignee is the only one who receives an e-mail notification of an assigned task and pertinent information related to that task. Alternatively, the teamspace owner may receive this e-mail along with the task assignee, e.g., through the teamspace invitation mechanism. Other information input by the process designer may be a workflow-aware flag. The workflow-aware flag may control both how the workflow proceeds for both non-workflow-aware tasks and workflow-aware tasks. It may differentiate treatment based on whether the flag indicates a task as workflow-aware or non-workflow-aware.

The workflow-aware flag may also be used on the collaboration side to determine whether workflow integration processing is needed to return to the workflow. When a workflow step checks a workflow-aware flag and it's false indicating a non-workflow-aware task, the workflow completes the step and moves to the next step in the workflow. If the flag indicates a workflow-aware task, then workflow controls the flow of collaboration tasks as indicated in greater detail hereinbelow.

Other parameters may be required for designing workflow-aware tasks. For example, a workflow queue name that may be used to dispatch a workflow-aware task. A workflow object (WOB) number may also be used if a task is workflow-aware. Other information such as due dates may be defined for a workflow-aware task. A reminder date may also be defined for a workflow-aware task.

Collaboration tasks may be initialized and assigned, with control returning to the workflow after the tasks are created. A workflow aware collaboration task may cause the workflow to wait until the collaboration task has been marked complete. In this case, a workflow step must create only a single workflow-aware collaboration task so that the collaboration can dispatch the workflow appropriately. The workflow should be designed such that the collaboration tasks are created and processed in the manner they are intended to control the collaboration flow.

After a collaboration task has been created by a workflow, a task assignee may log into the collaboration environment and open the assigned task. It is possible that the user interface may not reflect whether the task is workflow-aware or not. The member may be able to view task attachments assigned from workflow. The member may process the task which may include adding new attachments. When finished, the assignee may mark the task complete. Any new folder or document attachments may be added back to the workflow object if the task is workflow-aware.

Using a Workflow to Control the Flow of Collaboration Tasks:

A workflow may also control the flow of collaboration tasks. For example, a workflow may be designed to control when collaboration tasks are created and handled. Accordingly, therefore the workflow will wait until the collaboration task has been completed before continuing. This is viewed as synchronous behavior of creating and completing a collaboration task within a workflow before continuing the workflow.

The process designer may create a workflow which creates collaboration tasks and waits for their completion before moving to the next step in the workflow. The workflow step may create a collaboration task as indicated above except that the workflow step must specify that this is a workflow-aware task. This may be done by indicating the workflow-aware flag as true. After creating the task, the workflow will find the flag to be true, transfer the step to a holding queue and wait for the collaboration task to be completed.

In operation, the collaboration task assignee receives an e-mail and logs into the collaboration environment. The assignee may open the task to process it. The assignee may wish to specify attachments to be added to the task. The assignee will add attachments through a user interface.

The task assignee may reassign the task or finish the task and mark it complete. Upon completion of the collaboration task, workflow attachments may be updated or new attachments may be added to the workflow from the collaboration.

When the collaboration task is marked complete, the collaboration environment will find the workflow step and complete it. This will re-dispatch the step to the next step in the workflow. The designer will generally make sure that this kind of collaboration task cannot be deleted since it is needed to dispatch the workflow.

Using a Workflow to Add Content to a Teamspace:

A workflow may also add content to a teamspace. Content may also be repurposed in that a workflow may file content that already exists in an object store into an existing teamspace. A workflow should be allowed to add documents or folders into the teamspace for reference or to be worked on. The process designer may create a workflow using palette steps. Alternatively, the process designer may create custom steps to add workflow folder attachments or document attachments to a specified teamspace.

Creating Collaboration Steps in a Workflow:

As yet another example of the integration between a collaborative environment and business process management, a workflow may be created that uses collaboration steps. To this end, the workflow designer may include collaboration functionality in a workflow by using predefined steps offered by a collaboration system or create custom steps of his own in a process designer. To integrate the workflow with the collaboration system's predefined steps, the workflow designer may have to base the workflow on a sample collaboration base workflow. When using these predefined steps, required fields for collaboration may be inherited, and the workflow designer will have to create workflow steps to gather and provide data to the required fields of the predefined steps. The predefined steps may be offered as palette steps to enhance the workflow designer's experience.

As yet another example of the integration between the collaborative environment and business process management, workflows may be created within the collaboration environment. A designer may launch the process designer, and proceed to design the desired workflow.

As still yet another example of the integration between the collaborative environment and business process management, ad-hoc collaboration may occur from a workflow step. Such a workflow step may be, for example, one of the steps of a line of business workflow such as that described hereinabove in the insurance claims process example. A step involving review of the claim by a team of knowledge workers might require ad-hoc collaboration, for instance.

Ad-Hoc Collaboration from a Workflow Step:

A line of business workflow may be in process and a user may receive a step to process. The user may decide that he needs to collaborate to process the step that was assigned to him. The user may log in to a collaborative environment, collaborate, and complete the workflow step.

The user may desire temporary use of collaboration. In this case, the user would receive a step and trigger collaboration. The step would be saved so the step would remain in the user's inbox. The user may be redirected to a team collaboration management home page that passes the user's credentials which will bypass the login using the single sign-on feature. The user that has been assigned the step and wishes to collaborate can then use an existing teamspace or create a new one. When the user who has been assigned the step has finished collaborating, the user may be required to open the step from their inbox, browse and add attachments as the workflow step permits, and complete the step.

For example, Jane creates a proposal for some new equipment and fires off an approval workflow which goes to her boss, Jack. Jack receives the approval step in his inbox. He opens the step and decides that the proposed expense would result in the budget being exceeded, so he creates a collaboration space to try to determine why this expense is necessary. He invites Jane and a VP as members into the collaboration space and populates it with the proposal and a collaboration task to determine if the proposal is warranted. Jack creates a collaboration task for the members to review the proposal and generates a meeting for them to discuss it. The members meet and decide that the proposal is justified and necessary. Jack completes the collaboration task. He then brings up the workflow step from his inbox and completes the workflow step.

A person who receives a workflow step may desire only partial integration of collaboration functionality. In this case, an assignee might receive a workflow step in his inbox, open it and trigger a collaborate action. Execution shifts from the workflow step processor to a user interface (which may be a wizard) used to gather collaboration environment data, create collaboration objects, and move the step to another queue. In some cases, it may be desired to show that the workflow is now involved in a collaborative environment; one mechanism may be to transfer the step to a well known collaboration queue. This can be done even if there are other fields on the original step. When the collaboration task is marked complete then the workflow needs to be re-dispatched with the step transferred back to the assignee's inbox. The assignee would open the step from his inbox, browse and add attachments as the workflow step permits and complete the step.

In this scenario, the user is allowed to select a teamspace or create a new one but the task cannot automatically be generated if the teamspace is not known. Hence, there is a requirement for a way to gather collaboration environment data to make decisions before creating the collaboration objects.

One way to gather collaboration environment data is to map data from the workflow step into the collaboration task, as exemplified in the following table. Since there is no workflow step priority, the collaboration task's priority will be set to the default, which may be medium priority.

TABLE 1

| | |
|---|---|
| Workflow field | Collaboration task property |
| F_Deadline | TaskDueDate |
| F_Reminder | TaskReminderDate |
| F_StepDescription | TaskDescription |
| F_StepName | Title |
| No matching field | Priority - leave empty to get |
| | default value |

A workflow step could have zero or more single attachments and zero or more attachment arrays. The collaboration API may provide access to a workflow attachments array so that attachments may be added back to the workflow step. Having a user interface specify only a selection of attachments arrays is also possible.

In still yet other cases, a person receiving a workflow step may desire collaboration to complete the step, where the step is transferred to a holding queue and automatically completed by collaboration. In such case, the assignee may receive a workflow step in his inbox, open it and trigger a collaborative action. Execution may shift from the workflow step processor to a user interface (which may be a wizard) used to gather collaboration environment data including the attachment array name, create collaboration objects, and move the step to another queue. When the task created in the collaboration environment is marked complete then the step is found, attachments are added, and the step is completed dispatching it to the next step in the workflow.

The user interface may allow the assignee to choose an existing teamspace (e.g., by searching for the teamspace), or collect data to create a new teamspace. In this user interface, a selection of object stores may be presented. The assignee may select an object store resulting in the folder hierarchy being displayed. The assignee may then drill down to select an existing teamspace or select an action to create a new teamspace.

Upon confirming selection of an existing teamspace, the user interface may be configured to use collaboration calls to create a task representing the workflow step, then move the step to another queue.

Upon choosing to create a new teamspace, fields may be presented to gather the information necessary to create, the teamspace. Collaboration API calls may be used to create the teamspace and a task representing the workflow step. The collaboration task may be created using the workflow step name, due date, reminder date, and assignee as the collaboration task assignee. The step will be moved to another queue to wait for the collaboration task to complete and re-dispatch the step.

Returning attachments to the workflow may be accomplished by getting the step parameter for the attachments array name given and adding attachments. If no name is given then no attachments can be returned to the workflow.

The user might also be able to open a collaboration object in context. In this case, the user might open a workflow step, switch to the attachments, and click on a teamspace to open it. The system may look for certain types of collaboration objects and corresponding URL's to call, which may be registered in certain files. A log-on token may be appended to the redirect call.

Workflows may also be configured from teamspaces. The system configuration may make workflows available to the teamspace based on the teamspace template from which the workflow is created. The teamspace template's workflows may be configured by an administrator when the collaboration application is deployed or as new workflows are deployed. To support workflows, the collaboration application and the component integrator operations may be configured to only create teamspaces from a teamspace template.

A collaboration administrator may be required to add workflow definitions to the collaboration store to make them available for association to teamspace templates. The administrator can register collaboration store workflows for use through teamspaces, folders or documents within a teamspace template. As new teamspaces are created they may be assigned use of any workflow defined in the teamspace template at the time the teamspace was created. Any subsequent changes to the template may not be reflected in the teamspace after it is created.

Integration of Records Management with Team Collaboration:

The team collaboration methods, systems and computer programs incorporate mechanisms designed to manage records of various types, including but not limited to, electronic documents and e-mails, physical records or artifacts, vital records and permanent records. A record can be any asset that an organization desires to maintain and manage in a reliable manner.

All team collaboration artifacts, such as teamspaces, discussion threads, ad-hoc tasks, polls, meetings, notes, calendar, and notifications, may be automatically declared or classified as records based on contextual information associated with an automated business process (or workflow) or contextual information associated with the teamspace itself. The collaboration system provides for collection and recordation of this kind of information, so that it may be later used during the process. This contextual information allows the automated business process or collaboration system to declare any team collaboration artifact as a record.

The declaration may be made from the user's workplace using entry templates, from a productivity tools suite such as MICROSOFT OFFICE.™, an email program such as MICROSOFT OUTLOOK.™, and events that automatically declare the record.

Upon declaration, the system may be designed so that the record cannot be deleted, even by the creator of the record. Access rights may be changed for a record that impacts the document's access rights.

Classification may occur based on a classification scheme or file plan that incorporates assigned codes or categories, or any other descriptive information used to manage a record, including, for purposes of the record's accessibility, retrieval, retention, disposition or any other management operations.

Contextual information associated with a business process or workflow, or a teamspace, may allow the automated business process or teamspace to classify a record associated with a collaborative environment and include appropriate subtypes.

A records management system that is integrated with business process management is further described in a concurrently pending patent application entitled “Automated Records Management Based on Business Process Management,” filed on or about Oct. 15, 2004, and assigned to the assignee of the current invention, the disclosure of which is fully incorporated by reference herein.

Further Details on Hardware and Software Configurations:

A computer processing system may operate in conjunction with a memory system, and user interfaces to design and implement the features of the teamspaces, business process management tasks and records management operations of the present disclosure.

The computer processing system may be configured to perform any or all portions of the functions described in this application, as well as other functions. For example, the computer processing system may be configured to manage the various components in the system, including the various objects, processes and relationships that are discussed herein. The computer processing system may be configured to create, delete and modify any or all of these components.

The computer processing system may be constructed from any type of computer processing system and may include computer hardware and/or software. The computer processing system may include a general purpose computer or a computer that is dedicated to the collaboration management system. The computer processing system may include a single computer or multiple computers and/or processors. When using multiple computers and/or processors, the multiple computers and/or processors may be at a single location or at several locations. When using multiple computers and/or processors, the multiple computers and/or processors may be interconnected by a network system, such as a local area network, a wide area network, and/or the Internet. The computer processing system may include any combination of these embodiments.

The memory system may include any type of memory system, including one or more hard disk drives, magnetic tape drives and/or RAMs. The memory system may consist of a single device or multiple devices. When multiple devices are used, they may all be at the same location or at different locations. When multiple devices are used, appropriate hardware and/or software may be used to facilitate their intercommunication.

Any one of the functions that are performed by the computer processing system may be performed in response to input from the user interface that originates with one or more users of the collaboration management system. The user interface may include any type of user interface components, including one or more keyboards, mice and/or display screens. The user interface may include appropriate software to process information. The user interface may include communication links to other computing systems and/or databases.

The memory system may contain a plurality of teamspace templates, data objects and other software objects. The memory may be configured to receive or include ad-hoc tasks as well as business process management driven tasks. The memory may also be configured to receive, or include, a plurality of workflow processes.

Each workflow process may represent a workflow process relating to the enterprise. The workflow process may be a fully automated workflow process or one that requires human intervention at one or more stages of the process. Processes related to the enterprise other than workflow processes may also be stored in the memory system.

Various teamspace templates may be stored in the memory system and managed by a template management system in the computer processing system. Each template may represent a particular type of teamspace. Under the control of the template management system, the user may create one or more teamspaces. The template management system may be configured to allow the user to create one of the teamspace templates based on an existing template software object.

The memory system may include a plurality of relationships. Each relationship may specify an association between two or more components in the team collaboration management system, such as between two or more of the ad-hoc data objects,or two or more of the workflow processes, or one or more of each.

The computer processing system may be configured to allow the user operating through the user interface to create, modify and/or delete one or more of the ad-hoc data objects, workflow processes, and/or relationships therebetween.

The memory system may include a version history which is created and managed by a version control system in the computer processing system. As changes are made to one or more of the components in the collaboration system, such as to one or more of the ad-hoc data objects, the version control system may retain information in the version history that will allow each component to be reconstructed to each of its states prior to each of the changes that are made to it. The information that is stored in the version history may include complete replicates of earlier component versions and/or merely information indicative of the changes that are made thereto.

The processing system may include a collaboration management system. The collaboration management system may be configured to cause one or more processes to be implemented.

A broad variety of processes may be implemented in connection with team collaboration. These processes may be stored separately, such as in the form of one or more of the workflow processes. They may also be stored as part of the team collaboration software objects.

One type of process can be to issue notifications. The collaboration management system may be configured to allow internal and/or external users (or organizations) to subscribe to teamspaces for the purpose of being notified whenever certain characteristics of the teamspace change or when certain processes are initiated or completed. Notifications may be sent by e-mail or otherwise.

A security system may be employed in the computer processing system to govern who may access teamspaces and the components that may be related to them. The security may be applied at various levels, including to groups of users and/or particular classes of information.

An audit system may be included in the computer processing system to keep an audit of accesses that are made, including accesses to the teamspaces. The audit system may keep track of who accesses a teamspace, when it is modified, who authorizes the modification, who generates documentation related to the teamspace, and when these events take place. All of this information may be reported on for auditing and compliance reporting purposes.

A navigation system may be included in the computer processing system to allow a user of the collaboration system to navigate from one component of the system, such as from an ad-hoc data object, to other components that are related to it. The navigation system may include functionality that allows all relationships to a particular component, such as to an ad-hoc data object or workflow process, to be displayed, and to allow the user to select from this display the next component with which the user wishes to work.

External management systems may be linked to the collaboration management system.

Links to related items may be added to objects, such as tasks, documents, meetings, polls, etc. These objects may be related to objects the user is viewing. The system permits the user to add links to new collaboration objects, existing collaboration objects, and other objects outside the collaboration object store. Objects in this latter category, i.e., those outside the collaboration store may include external web sites or documents checked into other object stores.

When the user selects a related items link, the system opens the object represented by the link in the appropriate detail view. Where the object is in a teamspace other than the current teamspace, a new browser window may open automatically so that the user may navigate in the previous teamspace as well as the new teamspace. The user may also link to an object in a deactivated teamspace, but in some cases, may not be permitted to modify the object in the deactivated teamspace.

A user may add related items links to other objects from a detail view of a teamspace object. When a related items link is added to another teamspace object, e.g., a meeting, poll, or document, a relationship may be defined between the two objects. When a related items link is added from a teamspace object to an object outside the teamspace, e.g., a document that has been checked into the object store, then a single link may be created.

Related items may be added in a highly intuitive manner that is easy for the user. For example, if the user wishes to add a new task, the user would simply choose new task from the detail view of a teamspace object, create the new task, and create a link to it. The user might also add the related item by linking the items to another item using the clipboard. The clipboard method may be particularly useful when the user cannot link an object to a new object of the same type. For example, if the user is viewing a task, the user may not generally add a new task as a related link. When linking one object to another of the same type using the clipboard, the user navigates to the object the user wishes to link to, or the user searches to locate the object. The user then selects the object so that it displays in a detail view. The user selects the copy to clipboard action to place the current object, e.g., a task, poll, discussion or other collaboration object, into the related items links clipboard. The user may then navigate back to the object the user was previously working with, and select the previously viewed object to display it in the detail view. In the related items area of the screen, the user may then select add, and then select related item from the list.

The user may link a collaboration object to an external object. From within a teamspace, the user selects the object the user wishes to link to so that it displays in the detail view. The user then selects add, and then selects related items from the list. The user may then select an external URL tab from the dialog screen The user then enters the URL to the object the user wishes to link to.

A user may also remove a related item from a list by selecting the object with the link the user wishes to delete. The user may then select remove, and thereafter select related items from the displayed list. The user may then delete the links to any objects the user no longer wishes to appear in the list.

The collaboration management system may include a rules-based regulatory reporting system. Regulatory reporting controls may be used to monitor collaboration status and plan scheduled activities. Exception reporting may be controlled automatically by the system, once certain pre-defined criteria are not met. Business rules may be combined with automated processes to support automatic notifications and reminders.

Trends and forecasts may be reported. Using a process analyzer and simulation tools, trends and patterns in collaboration may be identified and explored with “what-if” scenarios.

The previous description of the disclosed embodiments is provided to enable one skilled in the art to make or use the present disclosure. Various modifications to these embodiments will be readily apparent to those skilled in the art. The principles set forth herein may be applied to other embodiments without departing from the spirit or scope of the disclosure. Thus, the present disclosure is not intended to be limited to the embodiments shown herein but is to be accorded the widest scope consistent with the principles and novel features disclosed herein.

We claim:

1. A computer-based method for ad-hoc collaboration tasks and business process management driven steps, comprising:
creating a teamspace;
receiving at least one ad-hoc task related to the teamspace;
implementing at least one business process management workflow related to the teamspace, wherein the at least one business process management workflow includes business process management steps; and
wherein the teamspace or other collaboration-related artifact is automatically declared as a record.

2. The method of claim 1, wherein the business process management workflow is launched from the teamspace.

3. The method of claim 1, wherein the business process management workflow is launched from a document associated with the teamspace.

4. The method of claim 1, wherein the business process management workflow creates the ad-hoc task for the teamspace.

5. The method of claim 1, wherein the ad-hoc task is a workflow-aware task that must be completed before the workflow continues.

6. The method of claim 1, wherein the business process management workflow is configured to add documents or folders to the teamspace such that the documents or folders are accessible from the teamspace.

7. The method of claim 1, wherein the ad-hoc task is a synchronous task.

8. The method of claim 1, wherein the ad-hoc task is an asynchronous task.

9. The method of claim 1, wherein at least one of the collaboration task and business process management steps is simulated by a process simulator.

10. The method of claim 1, wherein at least one of the ad-hoc task and business process management steps is analyzed by a process analyzer.

11. The method of claim 1, wherein the teamspace is configured to receive ad-hoc tasks and business process management steps, and access information related to these tasks and steps.

12. The method of claim 1, wherein the teamspace is configured to schedule teamspace meetings and access information related to the scheduled teamspace meetings.

13. The method of claim 1, wherein the teamspace is configured to provide access to teamspace files and manage the teamspace files according to security access levels.

14. The method of claim 1, wherein the teamspace is configured to receive discussion-related input and provide access to discussion threads.

15. The method of claim 1, wherein the teamspace is configured to receive poll data and provide access to poll data.

16. The method of claim 1, wherein the ad-hoc task is received in order to accomplish at least one business process management step.

17. The method of claim 1, wherein the business process management workflow is made available to the teamspace based on a teamspace template that was used to create the teamspace.

18. The method of claim 1, wherein the business process management workflow is made available to the teamspace based on a platform configuration of workflow subscriptions.

19. The method of claim 1, wherein the teamspace is configured to permit a user to add and/or remove user-defined related objects to a teamspace, wherein each related object is associated with a teamspace object when the user selects a command present in a detailed view of the teamspace object.

20. The method of claim 1, wherein the teamspace is configured to add documents or folders to the business process management workflow such that the documents or folders are accessible from the business process management workflow.

21. Computer-readable media containing programming for ad-hoc collaboration tasks and business process management driven steps that, when executed on a computer, causes a processor to perform the steps of:
creating a teamspace;
receiving at least one ad-hoc task related to the teamspace;
implementing at least one business process management workflow related to the teamspace, wherein the at least one business process management workflow includes business process management steps; and
wherein the teamspace or other collaboration-related artifact is automatically stored as a record.

22. The computer program of claim 21, wherein the business process management workflow is launched from the teamspace.

23. The computer program of claim 21, wherein the business process management workflow is launched from a document associated with the teamspace.

24. The computer program of claim 21, wherein the business process management workflow creates an ad-hoc task for the teamspace.

25. The computer program of claim 21, wherein the ad-hoc task is a workflow-aware task that must be completed before the workflow continues.

26. The computer program of claim 21, wherein the business process management workflow is configured to add documents or folders to the teamspace such that the documents or folders are accessible from the teamspace.

27. The computer program of claim 21, wherein the ad-hoc task is a synchronous task.

28. The computer program of claim 21, wherein the ad-hoc task is an asynchronous task.

29. The computer program of claim 21, wherein at least one of the collaboration task and business process management steps is simulated by a process simulator.

30. The computer program of claim 21, wherein at least one of the ad-hoc task and business process management steps is analyzed by a process analyzer.

31. The computer program of claim 21, wherein the teamspace is configured to receive ad-hoc tasks and business process management steps, and access information related to these tasks and steps.

32. The computer program of claim 21, wherein the teamspace is configured to schedule teamspace meetings and access information related to the scheduled teamspace meetings.

33. The computer program of claim 21, wherein the teamspace is configured to provide access to teamspace files and manage the teamspace files according to security access levels.

34. The computer program of claim 21, wherein the teamspace is configured to receive discussion-related input and provide access to discussion threads.

35. The computer program of claim 21, wherein the teamspace is configured to receive poll data and provide access to poll data.

36. The computer program of claim 21, wherein the ad-hoc task is received in order to accomplish at least one business process management step.

37. The computer program of claim 21, wherein the business process management workflow is made available to the teamspace based on a teamspace template that was used to create the teamspace.

38. The computer program of claim 21, wherein the business process management workflow is made available to the teamspace based on a platform configuration of workflow subscriptions.

39. The computer program of claim 21, wherein the teamspace is configured to permit a user to add and/or remove user-defined related objects to a teamspace, wherein each related object is associated with a teamspace object when the user selects a command present in a detailed view of the teamspace object.

40. The computer program of claim 21, wherein the teamspace is configured to add documents or folders to the business process management workflow such that the documents or folders are accessible from the business process management workflow.

41. A system for ad-hoc collaboration tasks with business process management driven steps, comprising:
a device configured to create a teamspace;
memory configured to receive at least one ad-hoc task related to the teamspace;
a process engine system configured to implement at least one business process management workflow related to the teamspace, wherein the at least one business process management workflow includes business process management steps; and
a records management system configured to store the teamspace or other collaboration-related artifact as a record.

42. The system of claim 41, wherein the business process management workflow is launched from the teamspace.

43. The system of claim 41, wherein the business process management workflow is launched from a document associated with the teamspace.

44. The system of claim 41, wherein the business process management workflow creates an ad-hoc task for the teamspace.

45. The system of claim 41, wherein the ad-hoc task is a workflow-aware task that must be completed before the workflow continues.

46. The system of claim 41, wherein the business process management workflow is configured to add documents or folders to the teamspace such that the documents or folders are accessible from the teamspace.

47. The system of claim 41, wherein the ad-hoc task is a synchronous task.

48. The system of claim 41, wherein the ad-hoc task is an asynchronous task.

49. The system of claim 41, wherein at least one of the collaboration task and business process management steps is simulated by a process simulator.

50. The system of claim 41, wherein at least one of the ad-hoc task and business process management steps is analyzed by a process analyzer.

51. The system of claim 41, wherein the teamspace is configured to receive ad-hoc tasks and business process management steps, and access information related to these tasks and steps.

52. The system of claim 41, wherein the teamspace is configured to schedule teamspace meetings and access information related to the scheduled teamspace meetings.

53. The system of claim 41, wherein the teamspace is configured to provide access to teamspace files and manage the teamspace files according to security access levels.

54. The system of claim 41, wherein the teamspace is configured to receive discussion-related input and provide access to discussion threads.

55. The system of claim 41, wherein the teamspace is configured to receive poll data and provide access to poll data.

56. The system of claim 41, wherein the ad-hoc task is received in order to accomplish at least one business process management step.

57. The system of claim 41, wherein the business process management workflow is made available to the teamspace based on a teamspace template that was used to create the teamspace.

58. The system of claim 41, wherein the business process management workflow is made available to the teamspace based on a platform configuration of workflow subscriptions.

59. The system of claim 41, wherein the teamspace is configured to permit a user to add and/or remove user-defined related objects to a teamspace, wherein each related object is associated with a teamspace object when the user selects a command present in a detailed view of the teamspace object.

60. The system of claim 41, wherein the teamspace is configured to add documents or folders to the business process management workflow such that the documents or folders are accessible from the business process management workflow.
